(19) United States
(12) Patent Application Publication
(10) Pub. No.: US 2003/0178476 A1
(43) Pub. Date: Sep. 25, 2003

(54) Solder paste, electronic -component assembly and soldering method

(76) Inventors: Kazuhisa Kanai, Chigasaki-Shi (JP); Makoto Takeuchi, Yokohama-Shi (JP)

Correspondence Address: JACOBSON HOLMAN, PROFESSIONAL LIMITED LIABILITY COMPANY, 400 Seventh Street, N.W., Washington, DC, 20004, US

(21) Appl. No.: 10/390,672

(22) Filed: Mar. 19, 2003

(30) Foreign Application Priority Data
Mar. 19, 2002 (JP) 2002-077349
Jan. 14, 2003 (JP) 2003-006265

(51) Int. Cl. B23K 31/02

(52) U.S. Cl. 228/248.1; 148/24

(57) ABSTRACT

A solder paste includes a first solder powder having an alloy of at least Sn and Zn and a second solder powder having a solidus temperature lower than an eutectic or a solidus temperature of the first solder powder, the first and the second solder powders being mixed into flux. The first solder powder may include an alloy of Sn-aZn-ba (5≦a≦12, 0≦b≦5) in which α is Bi or In. The second solder powder may include an alloy of Sn-cBi-dAg-eα, Sn-cBi-dZn-eβ or Sn-cBi-fIn-eα (1≦c≦57, 0≦d≦5, 0≦e≦5 and 0≦f≦52) in which α is Bi or In, and “a”, “b”, “c”, “d” and “e” indicate weight by percent, a mixture ratio of the first to the second solder powder being A:1 (1.5≦A≦10).

### BACKGROUND OF THE INVENTION

The present invention relates to a lead-free solder paste, an electronic-component assembly and a soldering method, for soldering electronic components such as a chip of semiconductor integrated circuitry on a printed circuit board, etc.

Solder pastes are used for soldering several types of electronic components such as semiconductor integrated circuitry on the surface of a printed circuit board, in electronics industry, etc.

Such solder pastes are selectively applied on, for example, lands on a printed circuit board by a dispenser or through screen printing. Electronic components are mounted on the printed circuit board and made contact with the lands on which thin solder pastes have been applied. The printed circuit board is then placed in a furnace for reflow soldering the electronic components to the lands.

The reflow soldering is an operation to solder electronic components on a printed circuit board at a temperature of the melting point of a solder paste or higher.

Most popular solder paste used to include an alloy of Sn (tin) and Pb (lead) solder paste for its low melting point such as 183° C. However, Sn-Zn (alloy of tin and zinc) and Sn-Zn-Bi (alloy of tin, zinc and bismuth) solder pastes, disclosed, for example, in Japanese Unexamined Patent Publication No. 11(1999)-138292, have been used recently. Because it was revealed that lead causes environmental pollution.

Known as an Sn-Z n solder paste is, for example, Sn-9Zn solder paste having a melting point (eutectic temperature) of about 197° C. Known as an Sn-Zn-Bi solder paste is, for example, Sn-8Zn-3Bi solder paste having a melting point of about 187° C. (solidus temperature) to 197° C. ( liquidus temperature) .

The numerals attached to the atomic symbols indicate weight percent. Tin is the major component of these solder pastes.

Both types of solder paste have been widely used because they do not require lead, a cause of environmental pollution, even though they have relatively high melting points compared to Sn-Pb solder pastes.

Aside from these lead-free solder pastes, there are newly developed terminals, for electronic components, coated with thin gold films by gold plating, for lower soldering resistance.

Soldering to such terminals of electronic components coated with thin gold films by means of a solder paste could, however, produce a compound layer of Au and Zn in the interface between each terminal and a land of a printed circuit board due to reaction of zinc in the solder paste and gold coated on the terminal.

The terminals could easily be peeled off from lands due to proneness of the Au-Zn layer to thermal shock such as heat cycle, thus revealing low reliability.

Such phenomenon rarely happens to terminals coated with very thin gold films of, for example, about 0.1 cm, whereas, often happens to those with thicker films.

Moreover, soldering to Cu-made lands on a printed circuit board could produce a compound layer of Zn and Cu due to reaction of Cu on the surface of each land and Zn in a solder paste.

A thick or large Zn-Cu layer, if produced, poses a problem like the Au-Zn layer discussed above, thus also revealing low reliability.

There is a strong demand for solder pastes or soldering techniques that achieve high strength in soldering to terminals of electronic components with a large amount of compound of Sn and Cu (a major product) in reaction of solder pastes with terminals whereas a least amount of Au-Zn or Cu-Zn compounds.

### SUMMARY OF THE INVENTION

A purpose of the present invention is to provide a solder paste, an electronic-component assembly and a soldering method achieving high unsusceptibility to thermal shock and high reliability in soldering terminals coated with gold films using a solder paste.

The present invention provides a solder paste comprising: a first solder powder including an alloy of at least Sn and Zn; and a second solder powder having a solidus temperature lower than an eutectic or a solidus temperature of the first solder powder, the first and the second solder powders being mixed into flux.

Moreover, the present invention provides an electronic-component assembly comprising: at least one electronic component; and a printed circuit board, the electronic-component being soldered to the printed circuit board using a solder paste including a first solder powder including an alloy of at least Sn and Zn and a second solder powder having a solidus temperature lower than an eutectic or a solidus temperature of the first solder powder, the first and the second solder powders being mixed into flux.

Furthermore, the present invention provides a soldering method comprising the steps of: mixing a first solder powder and a second solder power in into flux, thus producing a solder paste, the first solder powder including an alloy of at least Sn and Zn and the second solder powder having a solidus temperature lower than an eutectic or a solidus temperature of the first solder powder; and soldering at least one electronic component having at least one terminal coated with a gold film to a printed circuit board using the solder paste.

### BRIEF DESCRIPTION OF DRAWINGS

FIG. 1 illustrates soldering an electronic component to a printed circuit board using a solder paste according to the present invention;

FIGS. 2A and 2B illustrate an enlarged terminal of the electronic component and also an enlarged pad of the printed circuit, before and after the soldering, respectively;

FIG. 3 shows a picture of a joint section taken under a microscope;

FIG. 4 shows a picture of a joint section taken under a microscope, according to the present invention;

FIG. 5 shows a picture of a joint section taken under a microscope, according to the present invention;

FIG. 6 illustrates a joint section of a terminal of an electronic component and a pad of a printed circuit board soldered by using a known Sn-8Zn-3Bi solder paste, corresponding to FIG. 3;

FIG. 7 illustrates a joint section of a joint section of a terminal of an electronic component and a pad of a printed circuit board, soldered by using a first embodiment of solder paste according to the present invention, corresponding to FIG. 4; and

FIG. 8 illustrates a joint section of another terminal of the electronic component and another pad of the printed circuit board, soldered by using the first embodiment of solder paste according to the present invention, corresponding to FIG. 5.

### DETAILED DESCRIPTION OF PREFERRED EMBODIMENTS

Preferred embodiments according to the present invention will be disclosed with reference to the attached drawings.

The inventors of the present invention conceived the invention based on the findings in that combination of Au or Zn with another element before reaction between Au and Zn avoids production of an Au-Zn or a Cu-Zn layer prone to thermal shock in the interface between soldered terminals and lands on a printed circuit board.

[Embodiment 1]

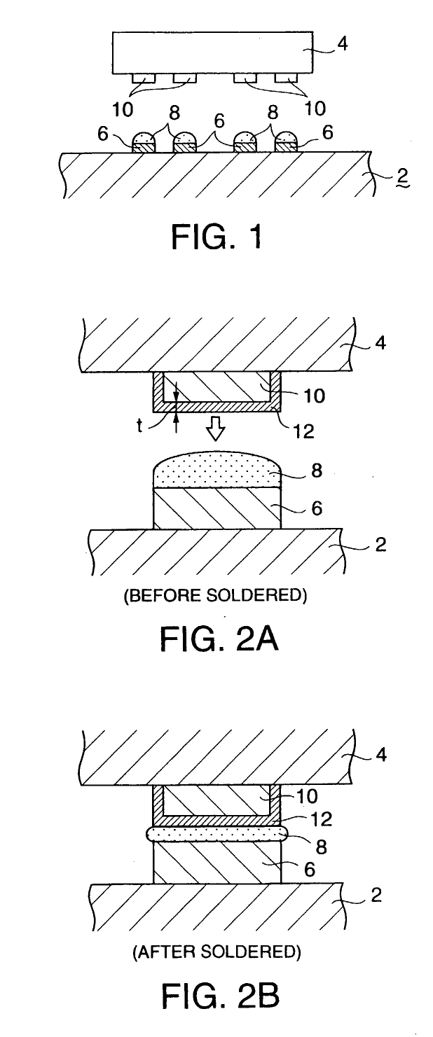

A solder paste according to the present invention is used, for example, in reflow soldering an electronic component 4 such as an integrated circuit on the surface of a printed circuit board 2, as illustrated in FIG. 1.

Mounted on the printed circuit board 2 are several pads 6 made of metal such as copper. Selectively applied on the surfaces of the pads 6 by a dispenser or through screen printing are solder pastes 8 according to the present invention.

Fixed under the electronic component 4 so as to match the pads 6 are terminals 10 each coated with a gold film 12 of a specific thickness “t” by gold plating, etc., for enhanced joint strength, as shown in FIG. 2A. The terminals 10 may be made of gold instead of gold plating.

Although only one electronic component 4 is shown in FIG. 1, several electronic components can be soldered to the printed circuit board 2.

The electronic component 4 is mounted on the printed circuit board 2 and then placed in a furnace for heating. Each terminal 10 is then jointed to the corresponding pad 6 via the solder paste 8, as illustrated in FIG. 2B, thus an electronic-component assembly according to the invention being finished.

The solder paste 8 according to the present invention is a lead-free solder paste so as not to cause environmental pollution.

In detail, the solder paste 8 (first embodiment) according to the present invention is made of a first solder powder including an Sn-Zn alloy and a second solder powder having a solidus temperature lower than an eutectic or a solidus temperature of the first solder powder, both powders mixed into flux.

Further in detail, the first solder powder may include an Sn- 9Zn alloy (9% by weight for Zn) whereas the second solder powder may include an Sn-10Bi-2.8Ag-0.6Cu alloy (10%, 2.8% and 0.6% by weight for Bi, Ag and Cu, respectively). The major component is tin (Sn) for both of the first and second solder powders.

The ratio of amount by weight for the mixture of the first and second solder powders is 70% (first powder) : 30% (second powder). The mixture is expressed as follows:

(Sn-9Zn)×70%+(Sn-10Bi-2.8Ag-0.6Cu)×30%

The first and second solder powders are mixed into flux, thus the solder paste 8 (first embodiment) being made.

The composition of the molten solder paste 8 is expressed as follows:

Sn-6.3Zn-3Bi-0.84Ag-0.18Cu

In this composition, the eutectic temperature of the first solder powder is about 197° C. whereas the solidus temperature of the second solder powder is about 181° C. lower than the eutectic temperature of the first solder powder and the liquidus temperature of the second solder powder is about 205° C.

Now the electronic component 4 mounted on the printed circuit board 2 via the solder paste 8 made of the first and second solder powders having the composition above is placed in a furnace.

The second solder powder is melted before the first solder powder, because of the low solidus temperature of the second solder powder. This allows diffusion of gold (Au) in the gold film on the surface of each terminal 10 and copper (Cu) on the surface of each pad 6 into the second solder powder. Gold or copper is reacted with tin (Sn), the major component of the second solder powder, thus an Au-Sn or a Cu-Sn alloy unsusceptible to thermal shock being produced.

Further temperature rise allows the first solder powder to melt, however, only few molten Au or Cu reacts with molten Zn in the melted first solder powder because of production of the Au-Sn or Cu-Sn alloy, thus an Au-Zn or a Cu-Zn layer being hardly produced, which may otherwise cause proneness to thermal shock.

In summary, the second solder powder containing a lot of material (Sn in the first embodiment) to be easily combined with Au and Cu is melted before the first solder powder, for earlier reaction of Sn with Au or Cu, thus preventing production of an Au-Zn or a Cu-Zn layer.

Further production of an Au-Sn or a Cu-Sn alloy can be promoted through reflow soldering by temperature-profile settings under consideration of inclination of temperature rise and a temperature range from the eutectic temperature of the first solder powder, when the first powder is eutectic, to the solidus temperature of the second solder powder or from the solidus temperature of the first solder powder, when the first powder is not eutectic, to the solidus temperature of the second solder powder.

The temperature-profile settings can be adopted as a method to further effectively prevent production of an Au-Zn or a Cu-Zn layer.

[Embodiment 2]

The solder paste 8 (second embodiment) according to the present invention is made of a first solder powder and a second solder powder having a liquidus temperature lower than an eutectic or a solidus temperature of the first solder powder.

In detail, the first solder powder includes an Sn-9Zn alloy (9% by weight for Zn), the same as the first embodiment, whereas the second solder powder includes an Sn-40Bi-0.1Cu alloy (40% and 0.1% by weight for Bi and Cu, respectively). The major component is tin (Sn) for both of the first and second solder powders.

The ratio of amount by weight for the mixture of the first and second solder powders is 70% (first powder) : 30% (second powder). The mixture is expressed as follows:

(Sn-9Zn)×70%+(Sn-40Bi-0.1Cu)×30%

The first and second solder powders are mixed into flux, thus the solder paste 8 (second embodiment) being made.

The composition of the molten solder paste 8 is expressed as follows:

Sn-6.3Zn-12Bi-0.03Cu

In this composition, the eutectic temperature of the first solder powder is about 197° C., the same as the first embodiment, whereas the solidus temperature of the second solder powder is about 138° C. lower than the eutectic temperature of the first solder and the liquidus temperature of the second solder powder is about 170° C. lower than the eutectic temperature of the first solder.

Like the first embodiment, the second embodiment prevents production of an Au-Zn or a Cu-Zn layer which may otherwise cause proneness to thermal shock.

In detail, the second solder powder containing a lot of material (Sn in the second embodiment) to be easily combined with Au and Cu is melted before the first solder powder, for earlier reaction of Sn with Au or Cu, thus preventing production of an Au-Zn or a Cu-Zn layer.

The thickness “t” of the gold layer 12 coated on each terminal 10 (FIG. 2A) is, for example, 0.3 μm or thicker, such as, about 0.6 μm, depending on manufacturers.

Discussed below is evaluation of the solder paste according to the present invention and a known solder paste against thermal shock.

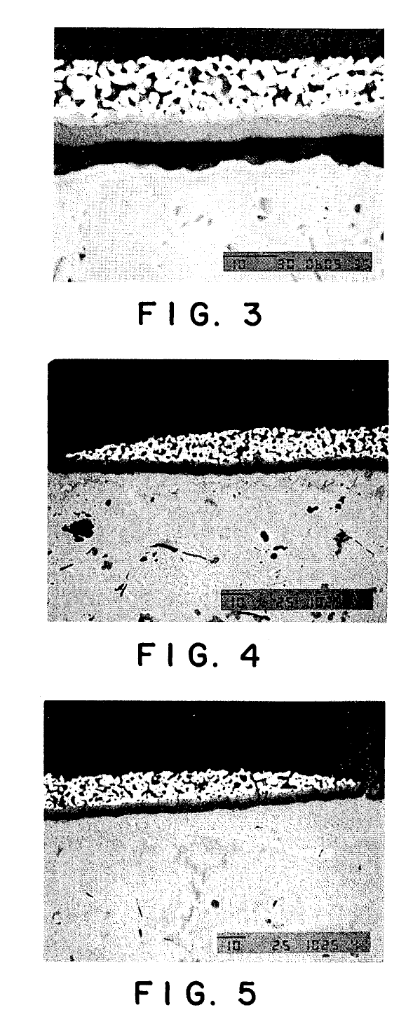

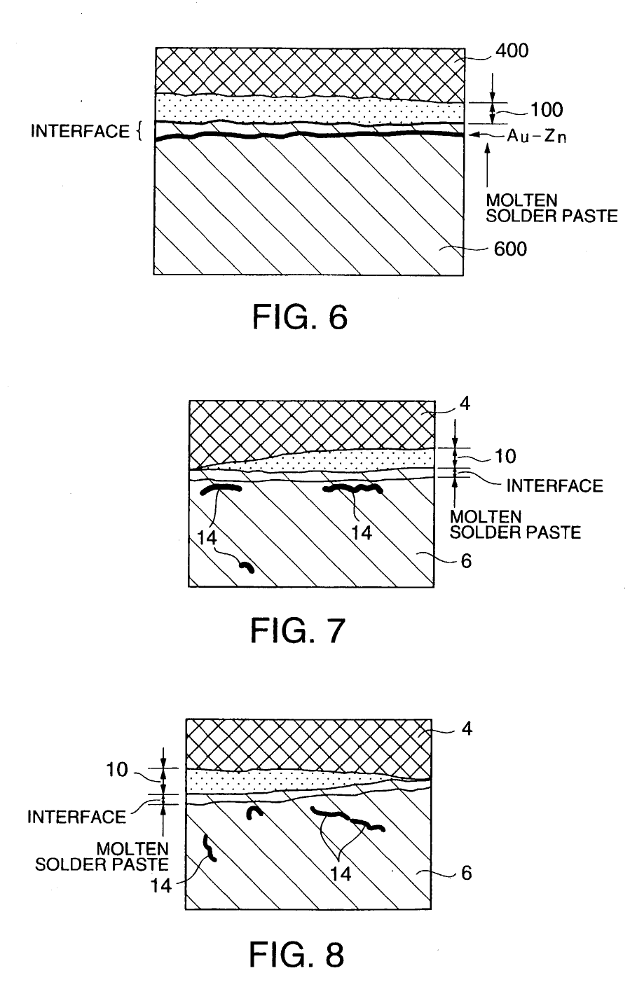

Illustrated in FIG. 6 is a joint section of a terminal 100 of an electronic component 400 and a pad 600 of a printed circuit board, soldered by using a known Sn-8Zn-3Bi solder paste. FIG. 3 shows a picture of the joint section taken under a microscope.

Illustrated in FIGS. 7 and 8 are two joint sections of terminals 6 of an electronic component 4 and pads 6 of a printed circuit board, soldered by using the solder paste 8 in the first embodiment. FIGS. 4 and 5 show pictures of the two joint sections taken under a microscope.

The thickness “t” (FIG. 2A) of the gold layer (12) coated on each terminal of the electronic components was 0.6 μm to the known solder paste and the first embodiment.

The pictures shown in FIGS. 3, 4 and 5 were taken after thermal shocks were given with 100-time repetition of heat cycles between −25° C. and 125° C. The soldered electronic components were left uncontrolled for 15 minutes at −25° C. and also 125° C. during each heat cycle.

Observations revealed the following facts for the known solder paste and the first embodiment.

As shown in FIGS. 3 and 6, an Au-Zn layer was produced in the interface between the terminal 100 and the known solder paste and then the electronic component 400 was peeled off from the solder paste and loosened after 100-time repetition of heat cycle.

Contrary to this, as shown in FIGS. 4, 5, 7 and 8, no Au-Zn layers were produced in the interface between the terminals 4 and the molten solder paste in the first embodiment, even though a few fragments of Au-Zn layers 14 were found scattered in the molten solder paste.

It was also found in FIGS. 4, 5, 7 and 8 that thermal shocks given with 100-time repetition of heat cycles caused no peeling off at the interface between the terminals 4 and the solder paste in the first embodiment, the electronic component 4 being thus not loosened.

The evaluation revealed high durability and also high reliability of the solder paste in the first embodiment.

The same evaluation is conducted at the thickness “t” (FIG. 2A) of 0.3 μm for the gold layer (12) coated on the terminals which provides almost the same results.

The first embodiment employs Sn-9Zn (9% by weight for Zn) solder powder as the first solder powder. Not only that, for example, Sn-8Zn (8% by weight for Zn) and Sn-11.5Zn (11.5% by weight for Zn) are available for the first solder powder.

Moreover, the first embodiment employs Sn-10Bi-2.8Ag-0.6Cu solder powder as the second solder powder. Not only that, for example, Sn-13Bi-3Zn is available for the second solder powder. One requirement for the second solder powder is the solidus temperature lower than the eutectic or solidus temperature of the first solder powder.

[Embodiment 3]

The third embodiment of solder paste according to the invention includes alloys of Sn-8Zn and Sn-13Bi-3Zn for the first and the second solder powders, respectively, at a ratio of 9:1, the composition of this molten solder paste being expressed as Sn-7.5Zn-1.3Bi.

[Embodiment 4]

The fourth embodiment of solder paste according to the invention includes alloys of Sn-9Zn and Sn-13Bi-3Zn for the first and the second solder powders, respectively, at a ratio of 9:1, the composition of this molten solder paste being expressed as Sn-8.4Zn-1.3Bi.

Discussed next is the types of alloy and ratio in composition for the first and the second solder powders and an effective mixture ratio of the first to the second solder powders, founded by the inventors of the present invention.

Alloys usable as the major component of the first solder powder are (Sn-Zn)-type alloys with a minor component a (Bi, In, etc.), at a composition ratio a : b : c (weight %), as follows:

Sn-aZn-bα (5≦a≦12, 0≦b≦5)

Alloys usable as the major component of the second solder powder are (Sn-Bi-Ag)-type alloys with a minor component α (Ga, Al, Cu, Zn, etc.) or β (Ga, Al, Cu, etc., Zn being not used) at a composition ratio c:d:e (weight %), as follows:

Sn-cBi-dAg-eα,

Sn-cBi-dZn-eβ or

Sn-cBi-fIn-eα

(1≦s≦57, 0≦d≦5, 0≦e≦5 and 0≦f≦52)

The three types of composition are listed, however, there is only one type at d=0, f=0 and α=β.

The mixture ratio of the first to the second solder powders is A:1 (1.5≦A≦10).

Therefore, the solder paste according to the present invention can be produced in accordance with the requirements discussed above for high durability and reliability.

Not only integrated circuits discussed above, the present invention is applicable to other types of electronic components, such as connectors, for soldering.

As disclosed above, the present invention achieves high durability and reliability against thermal shock in soldering of terminals coated with gold thin films.

What is claimed is:

1. A solder paste comprising:
a first solder powder including an alloy of at least Sn and Zn; and
a second solder powder having a solidus temperature lower than an eutectic or a solidus temperature of the first solder powder, the first and the second solder powders being mixed into flux.

2. The solder paste according to claim 1, wherein the second solder powder further has a liquidus temperature lower than the eutectic or the solidus temperature of the first solder powder.

3. The solder paste according to claim 1, wherein the first solder powder includes an alloy of Sn-aZn-bα (5≦a12, 0≦s≦5) in which a is Bi or In, and the second solder powder includes an alloy of Sn-cBi-dAg-eα, Sn-cBi-dZn-eβ or Sn-cBi-fIn-eα (1≦c≦52, 0≦d≦5, 0≦e≦5 and 0≦f≦52) in which a is Bi or In, and “a”, “b”, “c”, “d” and “e” indicate weight by percent, a mixture ratio of the first to the second solder powder being A:1(1.5≦A≦10).

4. An electronic-component assembly comprising:
at least one electronic component; and
a printed circuit board, the electronic-component being soldered to the printed circuit board using a solder paste including a first solder powder including an alloy of at least Sn and Zn and a second solder powder having a solidus temperature lower than an eutectic or a solidus temperature of the first solder powder, the first and the second solder powders being mixed into flux.

5. A soldering method comprising the steps of:
mixing a first solder powder and a second solder power in into flux, thus producing a solder paste, the first solder powder including an alloy of at least Sn and Zn and the second solder powder having a solidus temperature lower than an eutectic or a solidus temperature of the first solder powder; and
soldering at least one electronic component having at least one terminal coated with a gold film to a printed circuit board using the solder paste.
